(19) United States
(12) Patent Application Publication
(10) Pub. No.: US 2004/0248590 A1
(43) Pub. Date: Dec. 9, 2004

(54) Apparatus and method for presence-based call routing using computers

(76) Inventors: Kevin Chan, Ryde (AU); Alexander Michael Krumm-Heller, Chatswood (AU); Neil Hepworth, Artarmon (AU); Stephane Laveau, Paris (FR)

Correspondence Address: John C. Moran, Attorney, P.C., 4120 E. 115th Place, Thornton, CO, 80233, US

(21) Appl. No.: 10/456,005

(22) Filed: Jun. 6, 2003

(51) Int. Cl. H04Q 7/20

(52) U.S. Cl. 455/456.3; 455/445

(57) ABSTRACT

An apparatus and method allow the utilization of a computer normally utilized by a user of a telecommunication terminal to determine when a user is in close proximity to the telecommunication terminal.

### TECHNICAL FIELD

The present invention relates to telecommunication systems, and, in particular, to the detection of the presence of a user at a telecommunication terminal.

### BACKGROUND OF THE INVENTION

Within the prior art, the importance of determining when a user of a telecommunication terminal is physically close to the telecommunication terminal for receiving an incoming call has long been recognized. In the prior art, the user can before leaving the location of the telecommunication terminal manually activated the terminal to automatically transfer incoming calls to another telecommunication terminal. Also in the prior art, it is known for radio transmitters to be utilized by users so that the telecommunication terminal can detect when the user is in physical proximity of the telecommunication terminal. Infrared transmitters and receivers have also been utilized for this purpose. In addition, it is known to utilize an independent system using either radio or infrared transmitters carried by a user to determine the user's location with respect to their assigned telecommunication terminal.

Because of the need for special equipment to implement these prior art methods or the need for the user to perform a manually operation, the prior art methods have resulted in many problems and have not been readily implemented or used.

### SUMMARY OF THE INVENTION

The above-mentioned problems are solved and a technical advance is achieved in the art by an apparatus and method that allows the utilization of a computer normally utilized by a user of a telecommunication terminal to determine when a user is in close proximity to the telecommunication terminal.

### BRIEF DESCRIPTION OF THE DRAWING

FIG. 1 illustrates, in block diagram form, an embodiment in accordance with the invention;

FIG. 2 illustrates, in block diagram form, an embodiment in accordance with the invention;

FIGS. 3 and 4 illustrate, in flowchart form, operations performed by embodiments of the invention;

FIG. 5 illustrates, in block diagram form, a computer for implementing the embodiments of the invention;

FIG. 6 illustrates, in block diagram form, a computer implementing an embodiment of a soft phone; and

FIG. 7 illustrates, in flowchart form, operations performed by an embodiment of the invention

### DETAILED DESCRIPTION

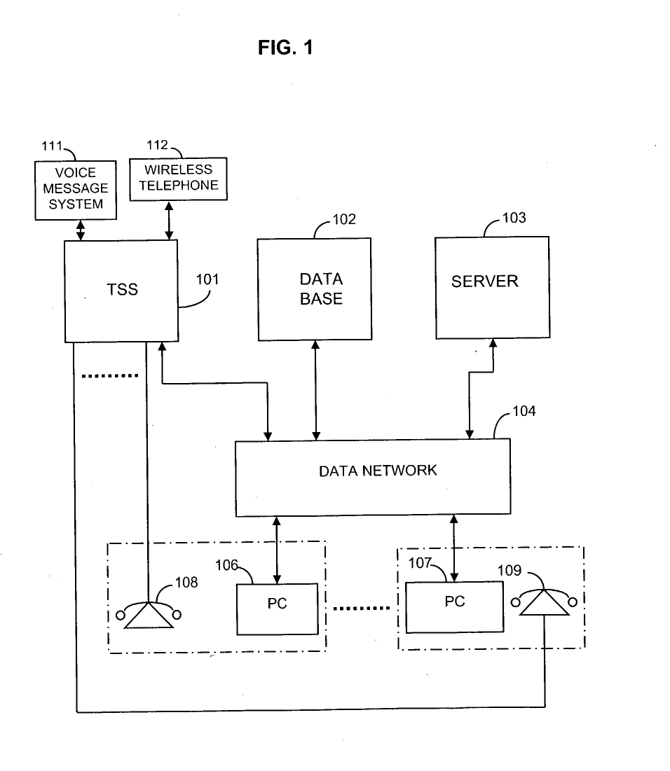

FIG. 1 illustrates, in block diagram form, an embodiment for implementing the invention. Telecommunication switching system 101 is providing telecommunication services to telephone sets 108-109. Data network 104 is providing data services for personal computers 106-107, server 103, database 102 and telecommunication switching system 101. Personal computer 106 is co-located with telephone set 108 and both devices are used by a common user. Similarly, personal computer 107 and telephone set 109 are co-located.

The presence of the user is determined by the activity of the user on their personal computer. For example, when personal computer 106 becomes idle as determined by the screen of personal computer 106 becoming locked, in one embodiment, personal computer 106 transmits a message to telecommunication switching system 101 via data network 104 requesting that telecommunication switching system 101 perform call forwarding. For example, telecommunication switching system 101 may forward calls for telephone set 108 to voice messaging system 111, wireless telephone 112, or a call coverage path manned by human operators.

In another embodiment of the invention, personal computer 106 upon detecting that it has entered the locked state, transmits a message via data network 104 to server 103. Server 103 then either accesses an internal database or information stored on database 102 to determine what telephone set is associated with personal computer 106. Once this determination is made, server 103 transmits a request to telecommunication switching system 101 via data network 104 requesting that telecommunication switching system 101 institutes a call forwarding operation with respect to telephone set 108. In another embodiment, the institution of call forwarding would also take into account the time of day.

One skilled in the art would readily realize that many communication mechanisms are known that would allow server 103 or personal computer 106 to communicate with telecommunication switching system 101 through other paths than those provided by a data network.

If personal computer 106 was implementing a soft phone, when the lockout condition occurred, personal computer 106 transmits information to telecommunication switching system 101 either directly or via server 103 requesting that calls directed to the soft phone being implemented on personal computer 106 be directed instead to telephone set 108 or another telephone. This operation resolves a well known problem in the prior art where a personal computer implementing a soft phone performs a screen lock, an incoming call occurs, and the call is lost because the user does not have time to unlock the personal computer and answer the call. In this situation, the call would be directed to telephone set 108.

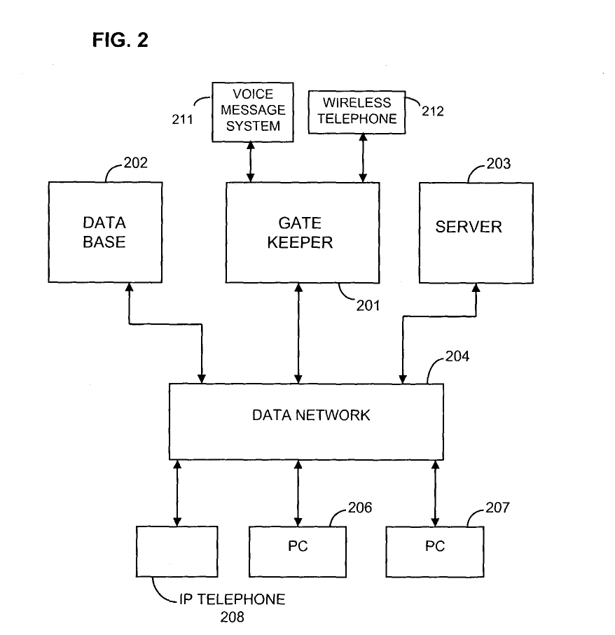

FIG. 2 illustrates, in block diagram form, the implementation of telephone services for IP telephones such as IP telephone 208 and soft phones such as soft phone 207 via data network 204 under the overall control of gatekeeper 201. In the following example, it is assumed that personal computer 206 is physically co-located with IP telephone 208. In one embodiment, when personal computer 206 detects that it is entering the locked state, it transmits a message to IP telephone 208 indicating that IP telephone 208 should commence call forwarding. IP telephone 208 may implement the call forwarding independent of gatekeeper 201 by being responsive to incoming calls to forward these calls in accordance with a predefined call forwarding path such as to voice mail system 211 or wireless telephone 212.

In another embodiment, IP telephone 208 is responsive to the message from personal computer 206 indicating that the user is not present to transmit a message to gatekeeper 201 requesting that gatekeeper 201 perform the call forwarding operations.

In yet another embodiment, when personal computer 206 determines that the screen has been locked, personal computer 206 transmits the message via data network 204 directly to gatekeeper 201 which performs the call forwarding operations. It is assumed that personal computer 206 has stored internal to itself the telephone number and IP address information for IP telephone 208.

In another embodiment, personal computer 206 transmits a notification of screen lock to server 203, and server 203 either directly communicates with IP telephone 208 to accomplish the call forwarding or communicates with gatekeeper 201 to accomplish the call forwarding operations.

Similarly, when soft phone 207 which is being implemented on a personal computer determines that its screen is being locked, it either internally implements call forwarding or requests that gatekeeper 201 implement the call forwarding operations.

In another embodiment, the presence information is used in the implementation of a hunt group. A hunt group is a list of telecommunication terminals maintained by a telecommunication switching system. If an incoming call is directed to one of the telecommunication terminal and is not answered, the telecommunication switching system transfers the incoming call to a telecommunication terminal on the list until the incoming call is answered or the list exhausted. In this embodiment, the telecommunication switching system determines whether to transfer the incoming call to a telecommunication terminal on the list using the presence information for that telecommunication terminal.

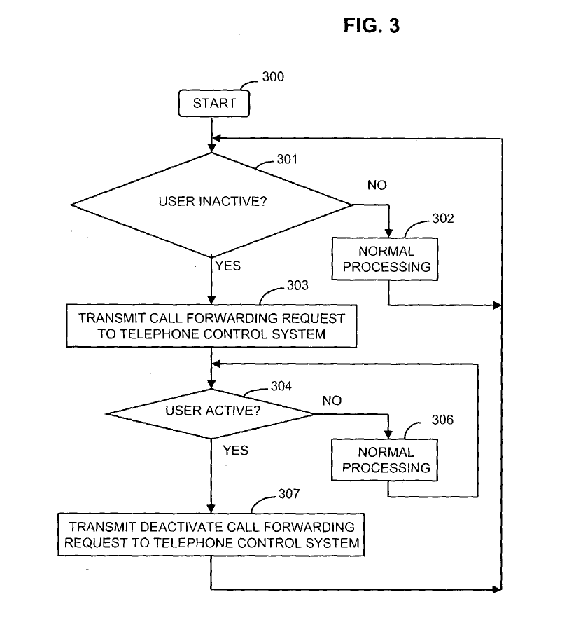

FIG. 3 illustrates, in flowchart form, operations performed to implement call forwarding based on the presence of the user. After being started in block 300, decision block 301 determines if the user is inactive. As previously noted, this can be done when the computer becomes locked because of inactivity. If the answer is no in decision block 301, block 302 performs normal processing before returning control back to decision block 301. If the answer in decision block 301 is yes, block 303 transmits a call forwarding request to the telephone control system. In one embodiment, the control system may be a telecommunication switching system or a gatekeeper. The call forwarding request includes the telephone number of the phone associated with the computer. The computer may store internally this telephone number in one embodiment; however in another embodiment, the computer may access this information from a server or a common database.

After execution of block 303, decision block 304 determines if the user has become active on the computer. If the answer is no, control is transferred to block 306 which performs normal processing before returning control back to decision block 304. If the answer is yes in decision block 304, block 307 transmits a deactivate call forwarding request to the telephone control system before returning control back to decision block 301.

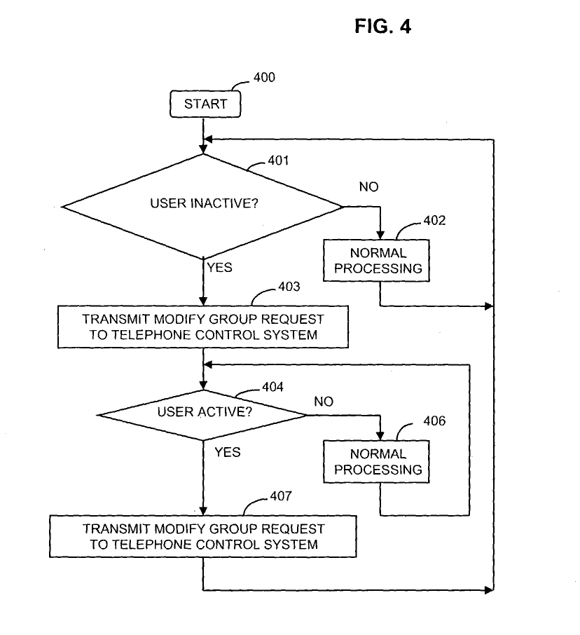

FIG. 4 illustrates, in flowchart form, operations performed to implement a hunt group based on the presence of the user. After being started in block 400, decision block 401 determines if the user is inactive. As previously noted, this can be done when the computer becomes locked because of inactivity. If the answer is no in decision block 401, block 402 performs normal processing before returning control back to decision block 401. If the answer in decision block 401 is yes, block 403 transmits a hunt group request to the telephone control system. In one embodiment, the control system may be a telecommunication switching system or a gatekeeper. The call forwarding request includes the telephone number of the phone associated with the computer. The computer may store internally this telephone number in one embodiment; however in another embodiment, the computer may access this information from a server or a common database.

After execution of block 403, decision block 404 determines if the user has become active on the computer. If the answer is no, control is transferred to block 406 which performs normal processing before returning control back to decision block 404. If the answer is yes in decision block 404, block 407 transmits a deactivate hunt group request to the telephone control system before returning control back to decision block 401.

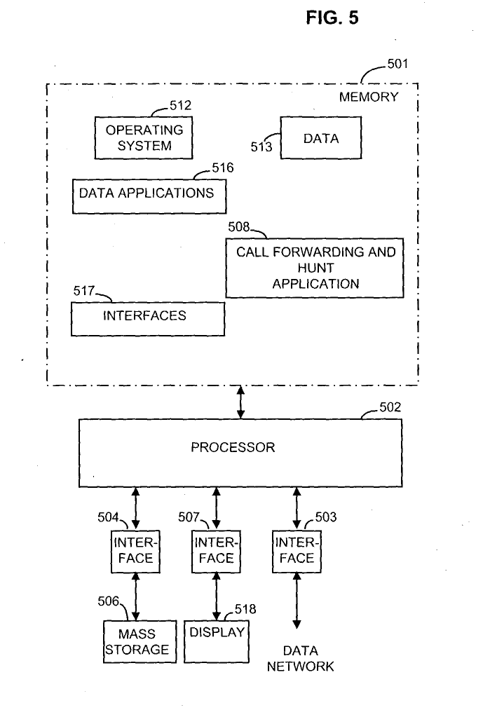

FIG. 5 illustrates, in block diagram form, one embodiment of a PC such as PC 106. Processor 502 provides the overall control for the functions of a PC by executing programs and storing and retrieving data from memory 501. Processor 502 connects to data network via interface 503. Processor 502 interfaces to display 518 via interface 507. Processor 502 performs the operations of a PC by executing the routines illustrated in memory 501.

Operating system 512 provides the overall control and the necessary protocol operations. Overall control of the data processing is performed by the PC under the control of data applications processing routine 516. The communication and control of the various interfaces illustrated in FIG. 5 is provided by interfaces routine 517. Call forwarding and hunt group application 508 controls the operations illustrated in FIGS. 3 and 4.

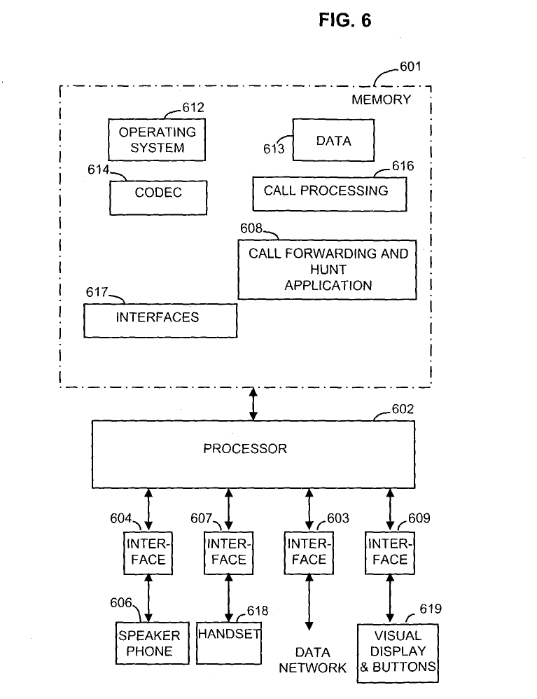

FIG. 6 illustrates, in block diagram form, one embodiment of a soft phone such as soft phone 206. Processor 602 provides the overall control for the functions of a soft phone by executing programs and storing and retrieving data from memory 601. Processor 602 connects to data network via interface 603. Processor 602 interfaces to handset 618 via interface 607 and connects to visual display and buttons 619 via interface 609. Visual display and buttons 619 is all of the indicators, buttons keypad, and display for a soft phone. Processor 602 performs the operations of soft phone by executing the routines illustrated in memory 601.

Operating system 612 provides the overall control and the necessary protocol operations. Data is stored in data block 613. CODEC 614 encodes and decodes the audio information for communication with handset 618 or conference speaker and microphone 606 for communication with network 103. Overall control of the call processing is performed by the soft phone under the control of call processing routine 616. The communication and control of the various interfaces illustrated in FIG. 6 is provided by interfaces routine 617. Route and timing application 608 controls the operations illustrated in FIGS. 3, 4 and 7.

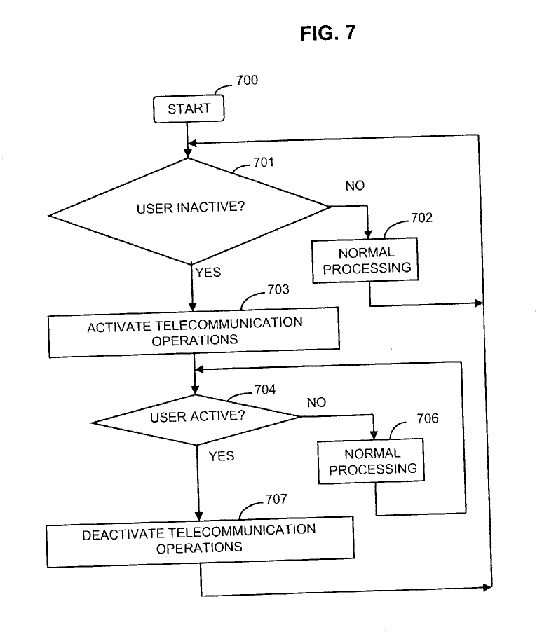

FIG. 7 illustrates, in flowchart form, operations performed to implement telecommunication operations based on the presence of the user by a computer also implementing a soft phone function. After being started in block 700, decision block 701 determines if the user is inactive. As previously noted, this can be done when the computer becomes screen locked because of inactivity. If the answer is no in decision block 701, block 702 performs normal processing before returning control back to decision block 701. If the answer in decision block 701 is yes, block 703 activates the telecommunication operations by causing the computer to perform these telecommunication operations. The call forwarding operations includes using the telephone number of the telephone associated with the computer. The computer may store internally this telephone number in one embodiment; however in another embodiment, the computer may access this information from a server or a common database.

After execution of block 703, decision block 704 determines if the user has become active on the computer. If the answer is no, control is transferred to block 706 which performs normal processing before returning control back to decision block 704. If the answer is yes in decision block 704, block 707 deactivates execution of telecommunication operations before returning control back to decision block 701.

When the operations of a PC or soft phone are implemented in software, it should be noted that the software can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The PC or soft phone can be embodied in any computer-readable medium for use by or in connection with an instruction execution system, apparatus, or device such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. For example, the computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance, via optical scanning of the paper or other medium, then compiled, interpreted or otherwise processed in a suitable manner if necessary, and then stored in a computer memory.

In an alternative embodiment, where the PC or soft phone is implemented in hardware, the PC or soft phone can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Of course, various changes and modifications to the illustrated embodiments described above will be apparent to those skilled in the art. These changes and modifications can be made without departing from the spirit and scope of the invention and without diminishing its intending advantages. It is therefore intended that such changes and modifications be covered by the following claims except insofar as limited by the prior art.

What is claimed is:

1. A method activating telecommunication operations based on a presence of a user at a computer, comprising the steps of:
detecting inactivity by the user of the computer for a period of time;
transmitting a message to a telecommunication gatekeeper requesting activation of the telecommunication operations; and
activating the telecommunication operations by the telecommunication gatekeeper.

2. The method of claim 1 wherein the step of activating comprises the step of selecting the telecommunication operations from a group consisting of call forwarding, hunt group, or ring group operations.

3. The method of claim 1 wherein the step of detecting comprises the step of determining a screen lock operation by the computer.

4. The method of claim 1 further comprises the step of implementing soft phone functions on the computer.

5. The method of claim 4 wherein the step of transmitting is performed by the computer.

6. The method of claim 1 wherein the step of transmitting is performed by a server interconnected to the computer.

7. The method of claim 6 further comprises the step of the computer signaling when inactivity is detected.

8. The method of claim 1 further comprises the steps of detecting activity by the user of the computer;
transmitting another message to the telecommunication gatekeeper requesting deactivation of the telecommunication operations; and
deactivating the telecommunication operations by the telecommunication gatekeeper.

9. The method of claim 8 wherein the step of deactivating comprises the step of selecting the telecommunication operations from a group consisting of call forwarding, hunt group, or ring group operations.

10. The method of claim 1 wherein the step of detecting comprises the step of determining an end to the screen lock operation by the computer.

11. The method of claim 8 wherein the step of transmitting the other message is performed by a server interconnected to the computer.

12. The method of claim 11 further comprises the step of the computer signaling when activity is detected.

13. A method activating telecommunication operations based on a presence of a user at a computer, comprising the steps of:
implementing soft phone operations by the computer;
detecting inactivity by the user of the computer for a period of time; and
performing the telecommunication operations by the computer in response to the detection of inactivity.

14. The method of claim 13 wherein the step of performing comprises the step of selecting the telecommunication operations from a group consisting of call forwarding, hunt group, or ring group operations.

15. The method of claim 13 wherein the step of performing comprises the step of transferring incoming telecommunication calls by the computer.

16. The method of claim 13 further comprises the steps of detecting activity by the user of the computer; and
deactivating the telecommunication operations by the computer.

17. The method of claim 16 wherein the step of deactivating comprises the step of selecting the telecommunication operations from a group consisting of call forwarding, hunt group, or ring group operations.

18. The method of claim 13 wherein the step of detecting comprises the step of determining an end to the screen lock operation by the computer.

19. A processor-readable medium comprising processor-executable instructions configured:
detecting inactivity by the user of the computer for a period of time;
transmitting a message to a telecommunication gatekeeper requesting activation of the telecommunication operations; and
activating the telecommunication operations by the telecommunication gatekeeper.

20. The processor-readable medium of claim 19 wherein the activating comprises selecting the telecommunication operations from a group consisting of call forwarding, hunt group, or ring group operations.

21. The processor-readable medium of claim 19 wherein the detecting comprises determining a screen lock operation by the computer.

22. The processor-readable medium of claim 19 further comprises implementing soft phone functions on the computer.

23. The processor-readable medium of claim 22 wherein transmitting is performed by the computer.

24. The processor-readable medium of claim 19 wherein the transmitting is performed by a server interconnected to the computer.

25. The processor-readable medium of claim 24 further comprises the computer signaling when inactivity is detected.

26. The processor-readable medium of claim 19 further comprises the steps of detecting activity by the user of the computer;
transmitting another message to the telecommunication gatekeeper requesting deactivation of the telecommunication operations; and
deactivating the telecommunication operations by the telecommunication gatekeeper.

27. The processor-readable medium of claim 26 wherein the deactivating comprises selecting the telecommunication operations from a group consisting of call forwarding, hunt group, or ring group operations.

28. The processor-readable medium of claim 19 wherein the detecting comprises determining an end to the screen lock operation by the computer.

29. The processor-readable medium of claim 26 wherein the transmitting the other message is performed by a server interconnected to the computer.

30. The processor-readable medium of claim 29 further comprises the computer signaling when activity is detected.

31. A processor-readable medium comprising processor-executable instructions configured:
implementing soft phone operations by the computer;
detecting inactivity by the user of the computer for a period of time; and
performing the telecommunication operations by the computer in response to the detection of inactivity.

32. The processor-readable medium of claim 31 wherein the performing comprises selecting the telecommunication operations from a group consisting of call forwarding, hunt group, or ring group operations.

33. The processor-readable medium of claim 32 wherein the performing comprises transferring incoming telecommunication calls by the computer.

34. The processor-readable medium of claim 31 further comprises the steps of detecting activity by the user of the computer; and
deactivating the telecommunication operations by the computer.

35. The processor-readable medium of claim 34 wherein the deactivating comprises selecting the telecommunication operations from a group consisting of call forwarding, hunt group, or ring group operations.

36. The processor-readable medium of claim 31 wherein the detecting comprises determining an end to the screen lock operation by the computer.

37. An apparatus for initiating telecommunication operations based on computer activity, comprising:
means for monitoring computer activity status;
means for determining a change of the computer activity status;
means for transmitting a message to a telecommunication gatekeeper requesting activation of the telecommunication operations in response to the determination; and
means for activating the telecommunication operations by the telecommunication gatekeeper.

38. The apparatus of claim 37 wherein the means for activating comprises means for selecting the telecommunication operations from a group consisting of call forwarding, hunt group, or ring group operations.
